(19) United States
(12) Patent Application Publication
(10) Pub. No.: US 2010/0155168 A1
(43) Pub. Date: Jun. 24, 2010

(54) WHEEL-ADJACENT MOTOR CONFIGURATION

(75) Inventor: Georg Mies, Wipperfurth (DE)

Correspondence Address: MCCORMICK, PAULDING & HUBER LLP, CITY PLACE II, 185 ASYLUM STREET, HARTFORD, CT, 06103, US

(73) Assignee: Klingelnberg AG, Zurich (CH)

(21) Appl. No.: 12/640,051

(22) Filed: Dec. 17, 2009

(30) Foreign Application Priority Data
Dec. 18, 2008 (EP) 08 172 122.7

(51) Int. Cl. B60K 7/00

(52) U.S. Cl. 180/300

(57) ABSTRACT

Vehicle having a wheel suspension, a wheel (1) to be driven, which is connected to the vehicle using the wheel suspension (40), and having an electric motor (20). The vehicle also comprises a bevel gear pair (30), which is directly connected to the wheel (1) and has a fixed gear reduction, and a shaft (42), which is situated between the electric motor (20) and the bevel gear pair (30) so that the electric motor (20) is connected by means of drive technology to the wheel (1) using the shaft (42) and the bevel gear pair (30). The fastening of the electric motor (20) on the vehicle is designed so that the electric motor (20) is essentially decoupled by means of movement technology from wheel movements (B2) of the wheel (1).

### CROSS REFERENCE TO RELATED PATENT APPLICATIONS

This patent application claims priority of the European patent application No. EP 08 172 122.7, filed on Dec. 18, 2008. The entire content of this priority defining application is incorporated herein by explicit reference for any purpose.

### FIELD OF THE INVENTION

The object of the invention is a device, referred to here as a wheel-adjacent motor configuration, for a vehicle, which is usable in particular in electric vehicles and/or hybrid vehicles. In addition, the invention relates to a vehicle having at least one such device.

### BACKGROUND OF THE INVENTION

### Prior Art

In connection with climate change, there is an urgent demand for alternative drives and drive concepts. Electric and/or hybrid drives have therefore obtained very great significance in particular. Various solutions are already known in this technical field, which use one or more electric motors either as the main drive or the auxiliary drive. Because the capacity of the batteries which provide the current for the electric motors is very limited, attempts are being made to improve the efficiency of such electric drives. This is possible, for example, by reducing the friction of the drive. In order to achieve such a reduction of the friction, for example, the number of components which deliver the power from the source to the destination can be minimized. An extreme case is when the electric motor drives the wheel directly. In this case, there is little loss between the electric motor and the driven wheel. This solution is referred to as a wheel hub motor. Although this solution appears very simple and advantageous at first glance, there are multiple disadvantages and difficulties. The main problem is that the wheels of a vehicle are typically not connected to the vehicle fixedly, but rather by a wheel suspension, whereby the vehicle is sprung. The wheels are then a part of the unsprung mass. This means that the wheels, including the wheel hub motors, move in various directions in relation to the vehicle when the vehicle is being driven. In order to allow the required movement freedom, various joints and suspensions are used. For example, a classical drive uses an array of constant velocity joints in order to be able to connect a power plant seated in the vehicle to the moving wheels. In the case of wheel hub motors, where the electric motor lies directly at or on the wheel axle without additional joints, the entire electric motor is part of the unsprung mass of the wheel. This aspect has various disadvantageous consequences, for example, the electric motor is directly subjected to all vibrations and forces. In addition, it is generally known that the automobile runs more smoothly the lower the unsprung mass. Therefore, a reduction of the unsprung mass is generally desirable, which can be achieved by using light metal rims, for example. If a wheel hub motor is used, however, the unsprung mass rises significantly. This has a large negative influence on the driving comfort in general.

A further disadvantage of the wheel hub motor is that the components located directly in proximity to the wheel are subjected to dirty water and all other possible environmental influences. Furthermore, because the brakes are also located in direct proximity to the drive elements, there are thermal problems due to the mutual heating of motor and brake. In addition, because of the small installation space available in the interior of the rim, the cooling of these components is problematic.

One of the greatest disadvantages of the wheel hub motor, which has not been able to be solved completely up to this point, is that costly multipole motors having large diameters must be used if reduction gear steps are to be dispensed with.

Wheel hub motors and other direct drives have the following disadvantages:
high unsprung mass, because the relatively heavy electric motor moves up and down with the wheel;
the components located in direct proximity to the wheel are subject to the dirty water and all other possible environmental influences;
because the brakes are also located in direct proximity to the drive elements, there are additionally thermal problems due to the heating of motor and brake;
if one wishes to dispense with reduction gear steps, costly multipole motors having large diameters must be used, which in turn results in space problems in the interior of the rim;
large centrifugal forces arise on the wheel, which may have an interfering effect upon direction changes.

The French patent document FR 02726231 A1 discloses a solution where an electric engine is arranged so that its axis extends along a pivoting axis of a vehicle. That is the axis of this engine is parallel to the wheel axis. In order to be able to provide a drive connection between the engine and the wheel, two gear pairs and one shaft are required.

The U.S. Pat. No. 1,543,044 offers a solution where the engines are sitting above the wheels. A similar approach is disclosed in the documents GB 151035 A and DE 29601177 U1. It is a problem of these arrangements that the shafts, which connect the engines and the wheels, are to be constructed so that up and down movements of the wheels can be compensated.

The U.S. Pat. No. 1,481,405 discloses a solution where the engines are arranged in front or behind the wheels. Here the drive connection has to be designed so that a relative up and down movement of the wheels is possible while the engines remain in their given positions.

The international Patent application WO 00/32462 discloses an arrangement where several wheels are employed which are individually steerable.

A solution where wheels with a rigid axis are employed, is disclosed in the German patent publication DE 196 17 165 A1. The electric engines are arranged next to the outer circumference of the wheels. Another solution is described in European patent application EP 1101645 A2. A complex arrangement of elements is necessary in order to provide for a drive connection between the engines and the wheels.

The object of the present invention is therefore to provide an electric drive for electric vehicles and/or hybrid vehicles, which is relatively simple, in order to be able to be used without significant changes on existing wheel suspension systems. In addition, this solution is to occupy as little space or installation space as possible.

A further object of the present invention is to provide a solution having higher efficiency, which offers a reduction of the friction of the drive.

Still a further object of the present invention is to provide a solution where the electric motor and further components of the drive are not subjected to dirty water and all other possible environmental influences.

Still a further object of the present invention is to provide a solution in which the thermal problems existing up to this point may be avoided simultaneously with the reduction of the friction of the drive.

### SUMMARY OF THE INVENTION

This object is achieved according to the invention by a so-called wheel-adjacent motor configuration, an electric motor not being directly in the area of the wheel hub, but rather being located laterally adjacent to the wheel, outside the inner peripheral area of the wheel, and being part of the sprung mass of the vehicle. This means that the electric motor does not move in solidarity with the wheel, but rather with the vehicle. The wheel is driven by the electric motor using a bevel gear pair having a fixed gear reduction. In this way, the speed of the electric motor is reduced and the use of compact electric motors having higher speeds is thus possible. Furthermore, the electric motor, depending on the concrete configuration, can either execute a longitudinal or an angular movement in relation to the wheel, without the (drive) connection between the electric motor and the wheel being interrupted. The device of the invention is designed so that the electric motor is part of the sprung mass of the vehicle and nonetheless occupies little space or installation space in the vehicle.

In order to maintain the (drive) connection between the bevel gear pair and the electric motor in spite of any angular movements, the shaft which connects the electric motor to the wheel by means of drive technology runs as much as possible from the neutral pivotal point of the vehicle-side end of the wheel suspension to the pivotal point of the wheel end of the wheel suspension. In this case, a ball spline shaft is no longer absolutely necessary. This embodiment, which allows small angular movements of the electric motors in relation to the wheel, is particularly advantageously usable in rear axle modules.

Preferably, as in known wheel hub motors, one electric motor is used per driven wheel. This has the advantage that, for example, individual activation of the wheels for the electronic stability program (ESP, ASR) is made possible, as are different torques to support the steering behavior when cornering. In addition, the differential gear, which is required in the event of central activation of multiple wheels, is dispensed with.

The most important advantage of the inventive configuration according to the present invention is therefore that the electric motors are part of the sprung mass, i.e., the unsprung mass of the wheel is not significantly increased in comparison to conventionally driven vehicles. This means that the device according to the invention does not have any noticeable negative effects on the driving or steering behavior of the vehicle.

A further advantage of the invention is that the same bevel gear pair is used simultaneously for reducing the speed, increasing the torque, and changing the axle direction, with the following effects:
Through the reduction of the speed, the use of compact electric motors having a favorable speed for high power density is possible.
The required torques on the wheel may be achieved using these compact electric motors by the increase of the torque.
Due to the change of the axle direction, the electric motor may be displaced in a particularly space-saving manner so that its mass does not become part of the unsprung mass on the wheel.
Through a special configuration in relation to the vehicle body or the suspension, the electric motor can be essentially decoupled from the movements of the wheel by means of movement technology.

Still a further advantage of the invention is that the wheel-adjacent motor configuration may be used without significant changes on existing wheel suspension systems.

Because the electric motor and further components of the drive are no longer located inside the wheel, and/or in the inner peripheral area of the wheel, they are no longer subjected to dirty water and all other possible environmental influences. Furthermore, the thermal problems which occur in wheel hub motors because of the direct proximity of the electric motor and the brake, are avoided.

The following advantages favor an electric drive according to the invention in direct proximity to the wheel to be driven:
reduction of the elements in the drive train, for example, the drive shafts having the required joints can be dispensed with;
less space required for the drive train (the conventional drive shafts require a comparatively large amount of space, because they are mobile). In electrically driven vehicles, this is of particular interest, because a larger amount of space is required for the batteries;
no differential gears (differential) required;
individual activation of the wheels for the electronic stability program (ESP, ASR) and different torques when cornering;
four-wheel drive can be implemented easily;
combination of typical drive on the front axle, for example, plus electric drive on the rear axle can be implemented very easily;
building block system for vehicles having typical drive, combined drive (see above), and purely electrical drive based on the same platform using exchangeable components.

Further Advantages of the Invention are:
the invention may be integrated ideally on the front axle in a MacPherson spring strut axle, for example;
the invention may be integrated ideally on the rear axle in a trailing arm axle or in a twist-beam rear axle, for example.

### BRIEF DESCRIPTION OF THE DRAWINGS

Further details and advantages of the invention are described hereafter on the basis of exemplary embodiments and with reference to the drawing. In the figures:

FIG. 1A shows a first embodiment of the wheel-adjacent motor configuration according to the present invention, the wheel being driven by the electric motor through a bevel gear pair;

FIG. 1A′ shows an embodiment of the wheel-adjacent motor configuration, which is similar to the embodiment shown in FIG. 1A, a larger and higher-performance electric motor being used;

FIG. 1B shows a schematic side view of FIG. 1A;

FIG. 1C shows a schematic side view, which shows the wheel according to FIG. 1A in an extreme position;

FIG. 2A shows a further embodiment of a wheel-adjacent motor configuration, the electric motor being fixedly connected to the vehicle and executing a vertical longitudinal movement in relation to the wheel, and the electric motor being connected to the wheel using a ball spline shaft;

FIG. 2A′ shows an embodiment of the wheel-adjacent motor configuration which is similar to the embodiment shown in FIG. 2A, a larger and higher-performance electric motor being used;

FIG. 2B shows a schematic view of a ball spline shaft used as a coupling shaft, which can be employed in the embodiment of FIG. 2A or 2A′;

FIG. 2C shows a schematic side view of a folded bellows coupling, which can be used as a coupling shaft and can be employed in the embodiment of FIG. 2A or 2A′, for example;

FIG. 2D shows a schematic view of a drive kinematic unit used as a coupling shaft, which can be employed in the embodiment of FIG. 2A or 2A′, for example;

FIG. 2E shows a schematic view of a further coupling shaft, which can be employed in the embodiment of FIG. 2A or 2A′, for example;

FIG. 3 shows a further embodiment of a wheel-adjacent motor configuration, the bevel gear pair being enclosed in a drive housing;

FIG. 4 shows a further embodiment of a wheel-adjacent motor configuration, a spring being situated concentrically to the shaft which connects the electric motor to the bevel gear pair;

FIG. 4′ shows an embodiment of a wheel-adjacent motor configuration which is similar to the embodiment shown in FIG. 4, a larger and higher-performance electric motor being used;

FIG. 5 shows a rear axle module having two wheel-adjacent motor configurations situated according to the invention; the electric motors being able to execute angular movements in relation to the wheels;

FIG. 6 shows a part of a rear axle module;

FIG. 7 shows a rear axle module having two wheel-adjacent motor configurations situated according to the invention;

FIG. 8A shows a schematic view of a further wheel-adjacent motor configuration, which encloses a 90° angle;

FIG. 8B shows a schematic view of a further wheel-adjacent motor configuration, which encloses an angle greater than 90°.

### DETAILED DESCRIPTION OF THE PREFERRED EMBODIMENTS

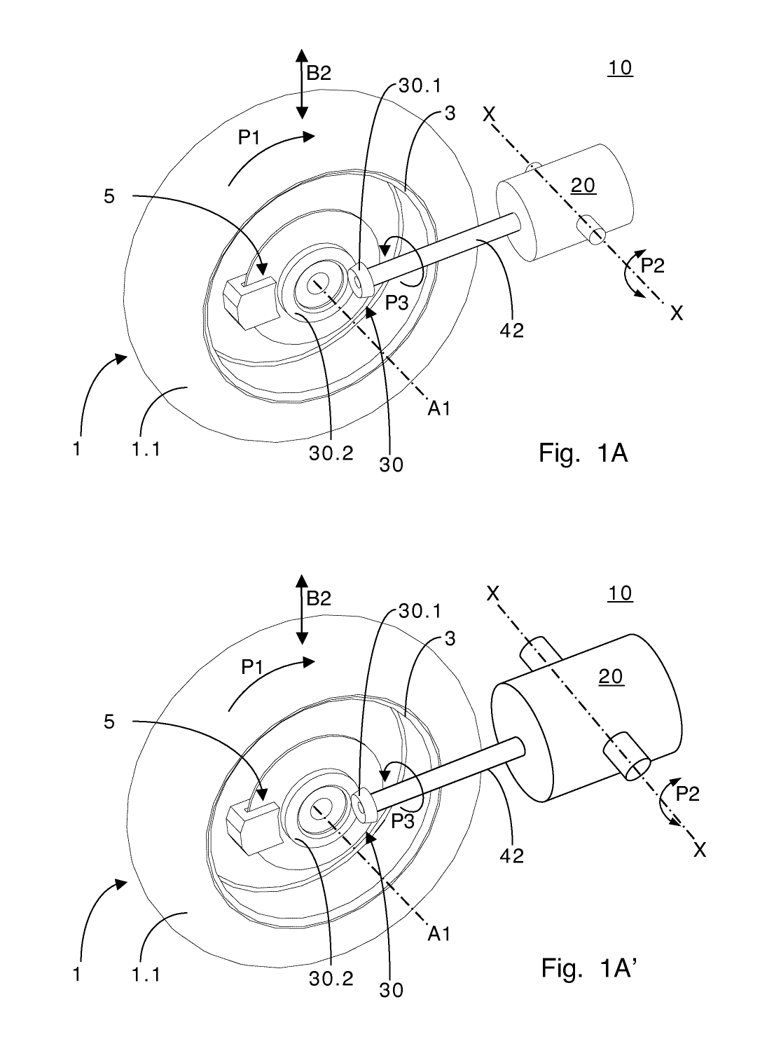

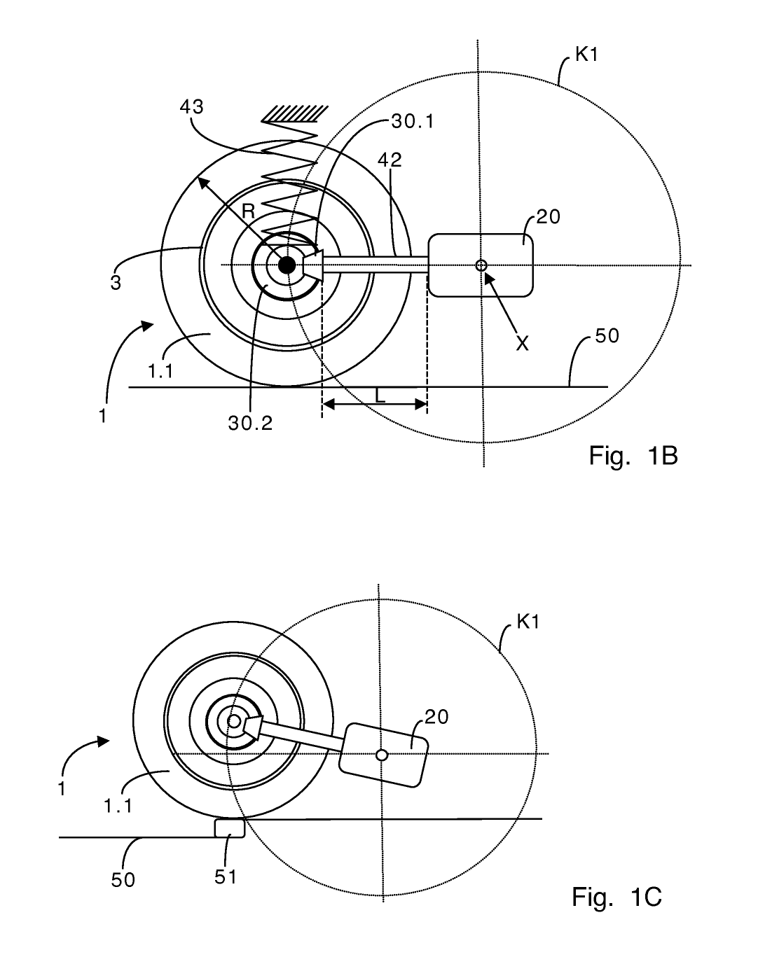

A first embodiment of the invention will be explained in relation to FIG. 1A. The wheel 1 of a vehicle is shown in FIG. 1A. The wheel 1 rotates around the axle A1 as the vehicle moves, as indicated by the arrow P1. The wheel hub is not shown, but runs concentrically to the axle A1.

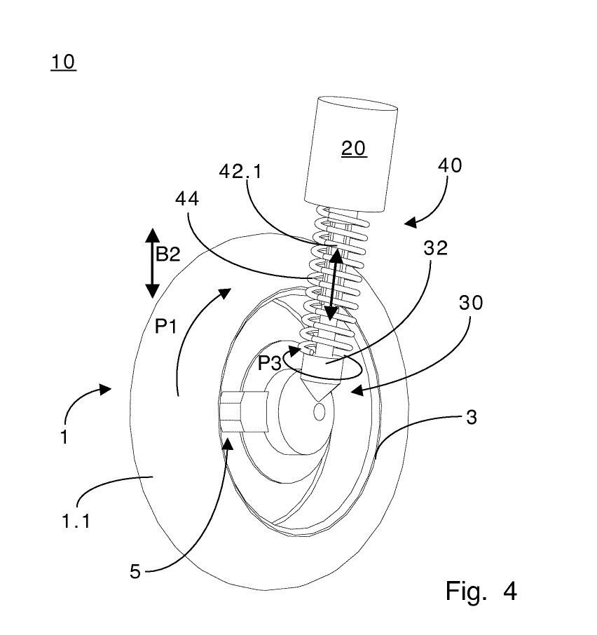

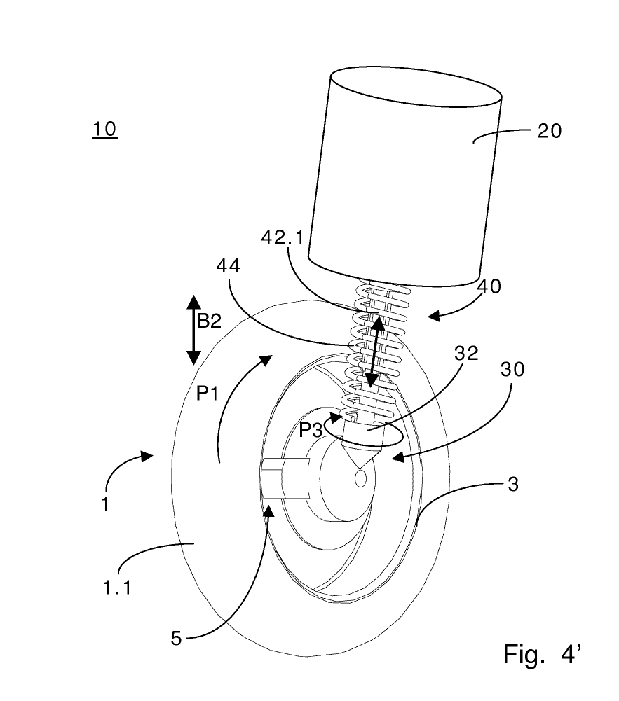

A first vehicle according to the invention comprises a wheel suspension 40 (see, for example, FIGS. 4, 4′, 5, 6, 7), a wheel 1 to be driven, which is connected to the vehicle using the wheel suspension 40, and an electric motor 20. The wheel suspension 40 is not shown in FIG. 1A. Furthermore, the vehicle comprises a bevel gear pair 30, which is connected directly to the wheel 1 and has a fixed gear reduction. A shaft 42 is situated between the electric motor 20 and the bevel gear pair 30 so that the electric motor 20 is connected by means of drive technology to the wheel 1 (i.e., for transmitting rotations) using the shaft 42 and the bevel gear pair 30. This means that the electric motor 20 converts a rotational movement upon application of a voltage or a current into a rotational movement of the shaft 42. This rotational movement is transmitted by a pinion 30.1 to a crown wheel 30.2. The crown wheel 30.2 is in turn connected to the wheel 1 so that the rotational movement of the crown wheel 30.2 is converted into a rotational movement of the wheel 1 around the axle A1. In this way, the wheel 1 can be driven directly by the electric motor 20. The drive occurs via a so-called angular gear configuration 30, which comprises a pinion 30.1 and a crown wheel 30.2 here. The angular gear configuration 30 is referred to here in general as a bevel gear pair 30. According to the invention, the fastening of the electric motor 20 on the vehicle is designed so that the electric motor 20 is essentially decoupled by means of movement technology from wheel movements B2 of the wheel 1.

The term drive-technology connection between the electric motor 20 and the wheel 1 is intentionally used in connection with the present invention. This term is to express the idea that the overall constellation is selected so that drive torques, i.e., rotational movements, are transmitted from the electric motor 20 to the wheel 1. Other movements which arise due to movements of the vehicle body relative to the wheel 1 are not transmitted by the drive-technology connection.

It is shown purely schematically in FIG. 1A that the electric motor 20 is mechanically fastened in the area of a vehicle-side end of the wheel suspension 40, which is connected directly to the vehicle. The fastening point is indicated in FIG. 1A by a line X-X. The line X-X runs precisely through the center of gravity of the electric motor 20 here. It is shown by the double arrow P2 that the wheel suspension 40 is designed so that the wheel 1, including wheel suspension 40, can be pivoted around this line X-X when the vehicle is in motion. The line X-X defines a quasi-neutral line. Correspondingly, the electric motor 20 is situated in this embodiment of the invention in relation to this line X-X and connected to the vehicle so that the spacing between the electric drive 20 and the wheel hub or axle A1 remains constant.

An embodiment is shown in FIG. 1A′ which corresponds to the embodiment according to FIG. 1A. The essential difference is that a significantly larger and higher-torque electric motor 20 is used. Such larger electric motors are used, for example, if the vehicle is to be equipped with better driving performance. It can be seen directly on the basis of FIG. 1A′ that such an electric motor 20 could not be housed in the interior of the rim 3 of the wheel 1. However, one has sufficient degrees of freedom to also use significantly larger motors 20 through the wheel-adjacent configuration.

It is indicated in FIG. 1B that the line X-X defines the center of a circle K1. The wheel 1 makes small angular movements around the line X-X, or around the center of the circle K1, when driving over obstacles. A state is shown in FIG. 1C in which the wheel 1 was moved a few degrees upward (clockwise) along the circumference of the circle K1. Such a situation can occur, for example, when the vehicle having the wheel 1 drives over a curbstone 51. It can be seen on the basis of FIG. 1C that the electric motor 20 rotates in solidarity accordingly. The spacing between the electric motor 20 and the axle A1 always remains equal, however.

It is shown purely schematically in FIG. 1B that a spring strut 43 and/or shock absorber is used as part of the wheel suspension 40 in order to damp the movements B2. The spring strut 43 is preferably connected to a housing of the bevel gear pair 30 or to a wheel hub bearing.

The following further details can be seen in FIGS. 1A, 1A′, FIG. 1B, and FIG. 1C. the wheel 1 comprises a tire 1.1, which is seated on a rim 3. A brake configuration 5 having brake disc, which is seated concentrically to the axle A1, and brake calipers is situated in the interior of the rim 3

A vehicle according to the invention is thus distinguished in that through the type and the location of the fastening (referred to here as the overall constellation) of the electric motor 20, the electric motor 20 is part of the sprung mass of the vehicle. Only the bevel gear pair 30 is seated directly on the wheel 1 and is part of the unsprung mass.

The location of the fastening of the electric motor 20, or the configuration itself, is thus essential for the use of an electric motor 20 with a bevel gear pair 30. Through the overall constellations or configurations described here, it is possible to situate the electric motor 20 outside the rim interior or entirely outside the circumference of the wheel 1 and nonetheless to connect it by means of drive technology to the wheel 1.

The location of the fastening of the electric motor 20, or the configuration itself, is preferably selected so that the shaft 42 has a shaft length L which corresponds to at least approximately half of the radius R/2 of the wheel 1.

Embodiments are shown in FIGS. 1A, 1A′ through 1C in which the electric motor 20 is mechanically fastened in the area of a vehicle end of the wheel suspension 40, which is connected directly to the vehicle.

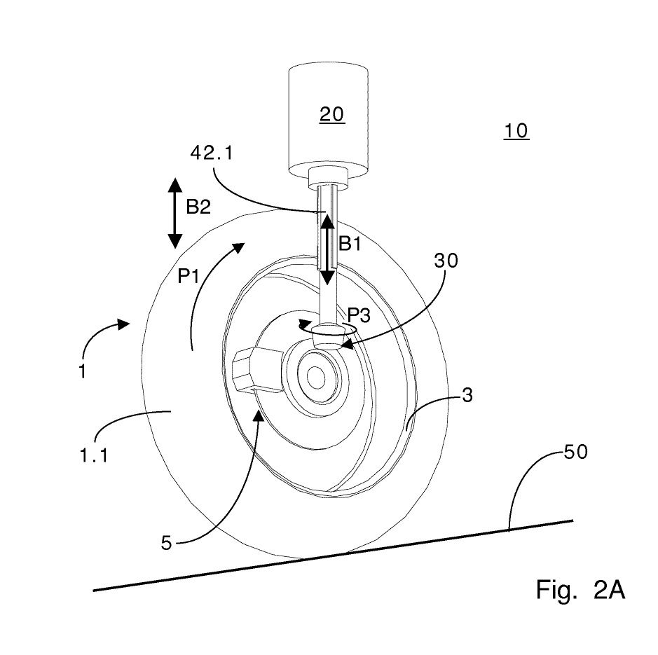

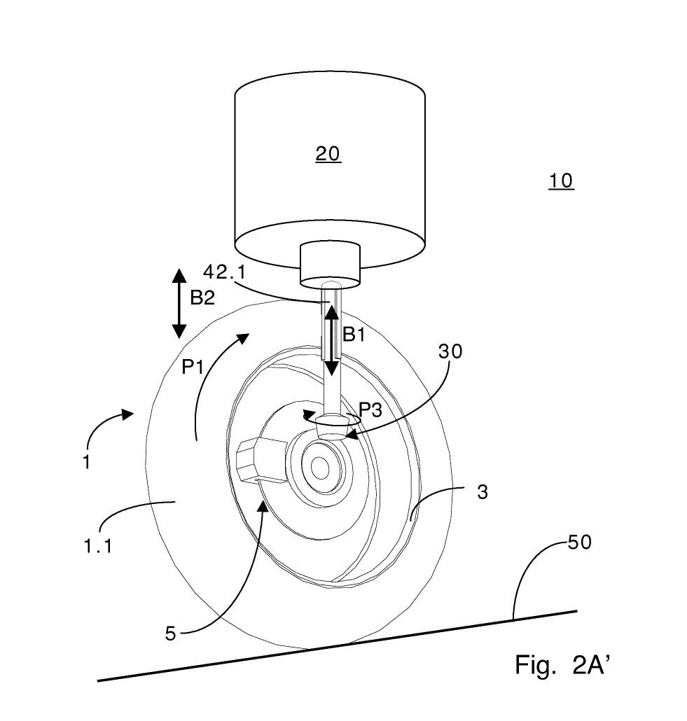

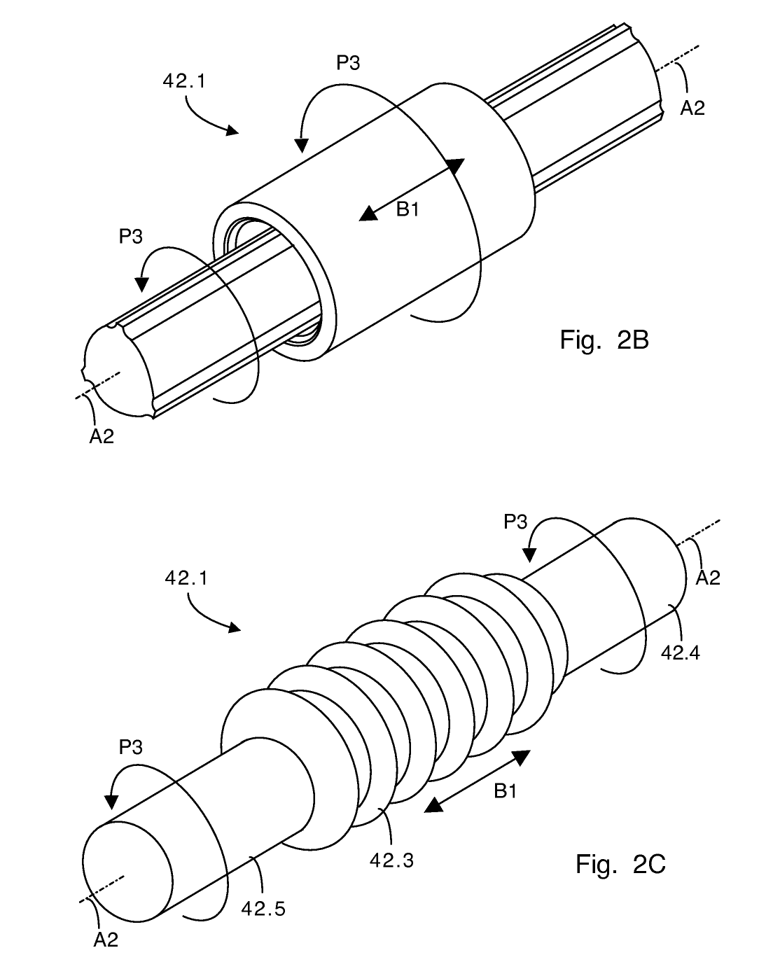

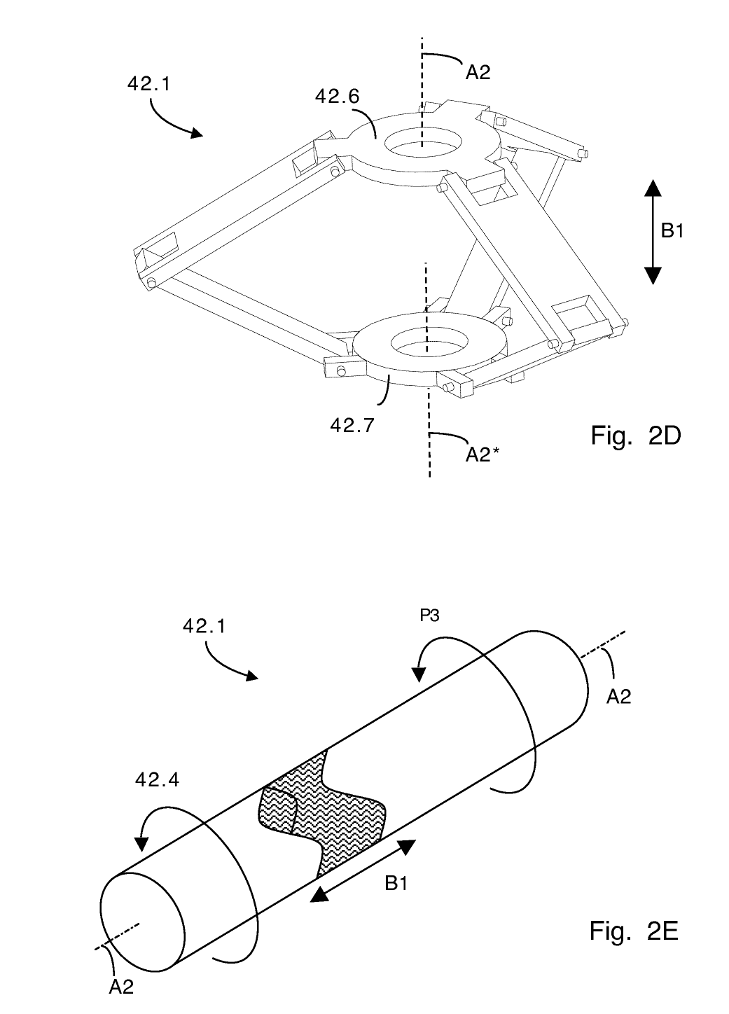

Another location of the fastening of the electric motor 20, or another configuration thereof, is shown in FIG. 2A. A second vehicle according to the invention again comprises a wheel suspension 40 (see, for example, FIGS. 4, 4′, 5, 6, 7), a wheel 1 to be driven, which is connected to the vehicle using the wheel suspension 40, and an electric motor 20. The wheel suspension 40 is not shown in FIG. 2A. The vehicle again comprises a bevel gear pair 30, which is directly connected to the wheel 1 and has a fixed gear reduction. A shaft 42 is situated between the electric motor 20 and the bevel gear pair 30 so that the electric motor 20 is also connected by means of drive technology to the wheel 1 using the shaft 42 and the bevel gear pair 30 in this embodiment. In this way, the wheel 1 can be driven directly by the electric motor 20. The drive occurs via a so-called angular gear configuration 30, which comprises a pinion 30.1 and a crown wheel 30.2 here. According to the invention, the fastening of the electric motor 20 on the vehicle is designed so that the electric motor 20 is also essentially decoupled by means of movement technology from wheel movements B2 of the wheel 1 in this embodiment.

In order to allow such a configuration of electric motor 20, shaft 42, bevel gear pair 30, and wheel 1, a so-called ball spline shaft 42.1 is used as the shaft 42 here. A ball spline shaft 42.1 is a shaft having variable shaft length L. According to the invention, the fastening of the electric motor 20 on the vehicle is designed so that the electric motor 20 is essentially decoupled by means of movement technology from wheel movements B2 of the wheel 1. In order to allow this in the overall constellation shown in FIG. 2A, the spacing between the electric motor 20 and the wheel hub of the wheel 1, or the crown wheel 30.2, must be variable. This variability is made possible in this embodiment by a ball spline shaft 42.1. The ball spline shaft 42.1 allows a drive connection to be maintained between the double gear pair 30 and the electric motor 20, in spite of longitudinal movement B2 of the wheel 1 in relation to the electric motor 20. The longitudinal movement B2 is preferably a movement which is oriented vertically to a road covering 50.

If the wheel 1 is moved upward relative to the vehicle body by a roadway irregularity, for example, the ball spline shaft 42.1 shortens. If the wheel 1 sinks downward somewhat, the ball spline shaft 42.1 lengthens. The corresponding compensation movement of the ball spline shaft 42.1 is indicated by the double arrow B1.

All other elements of the wheel 1 may be identical to those of the wheel 1 shown in FIGS. 1A, 1A′, through 1C.

An embodiment is shown in FIG. 2A′, which corresponds to the embodiment according to FIG. 2A. The essential difference is that a significantly larger and higher-torque electric motor 20 is used. Such larger electric motors are used, for example, if the vehicle is to be equipped with better driving performance. It can be seen directly on the basis of FIG. 2A′ that such an electric motor 20 could not be housed in the interior of the rim 3 of the wheel 1. However, one has sufficient degrees of freedom to also use significantly larger motors 20 through the wheel-adjacent configuration.

A schematic view of a ball spline shaft 42.1, which can be used in the embodiment of FIG. 2A, is shown in FIG. 2B. Such a ball spline shaft 42 allows rotational movements around the longitudinal axis to be transmitted. The drive-technology connection is thus ensured. The ball spline shaft 42.1 may also be stretched and compressed within certain limits, however. It is thus possible to compensate for a variation of the spacing between the bevel gear pair 30 and the position of the electric motor 20.

The ball spline shaft 42.1 is a component which is used to transmit rotational movements if greater axial displacements must be compensated for on the shaft. Relatively large torques (drive torques) may be transmitted without play. The friction upon displacement of the components of the ball spline shaft 42.1 in the axial direction is very low due to the use of balls as the roller bodies.

Instead of a ball spline shaft 42.1, a so-called folded bellows connection 42.1, as shown in FIG. 2C, can also be used in order to transmit drive torques from the electric motor 20 to the wheel 1, but also to ensure decoupling of translational movements simultaneously. The folded bellows 42.3 connects two shaft stubs 42.4 and 42.5 to one another so that both shaft stubs 42.4 and 42.5 rotate at the same rotational velocity, as indicated by the arrows P3. Translational movements are possible in the direction of the double arrow B1.

Instead of a ball spline shaft 42.1 or a folded bellows connection 42.1, a so-called drive kinematic unit 42.1, as shown in FIG. 2D, can also be used in order to transmit drive torques from the electric motor 20 to the wheel 1, but also to simultaneously ensure decoupling of translational movements. The kinematic unit 42.1 shown in the figure is also torsionally-rigid in the radial direction and can compensate for movements in the axial direction by three double joints. The upper ring 42.6 is intended for attachment to the electric motor 20, the lower ring 42.7 for attachment of a shaft stub which carries the pinion 30.1. The two axles A2 and A2* are decoupled in the translational direction (as indicated by the double arrow B1), while drive torques may be transmitted.

Instead of a ball spline shaft 42.1, a folded bellows connection 42.1, or a drive kinematic unit 42.1, a shaft connection 42.1, as shown in FIG. 2E, can also be used in order to transmit drive torques from the electric motor 20 to the wheel 1, but also to simultaneously ensure decoupling of translational movements. The shaft connection 42.1 can have a spiral peripheral slot in the outer peripheral area, for example. If the slotted shaft is pulled apart in the B1 direction, a body which is similar to a coiled spring or a bellows 42.3 is obtained.

The various possible shaft connections are referred to as a whole here as coupling shafts 42.1.

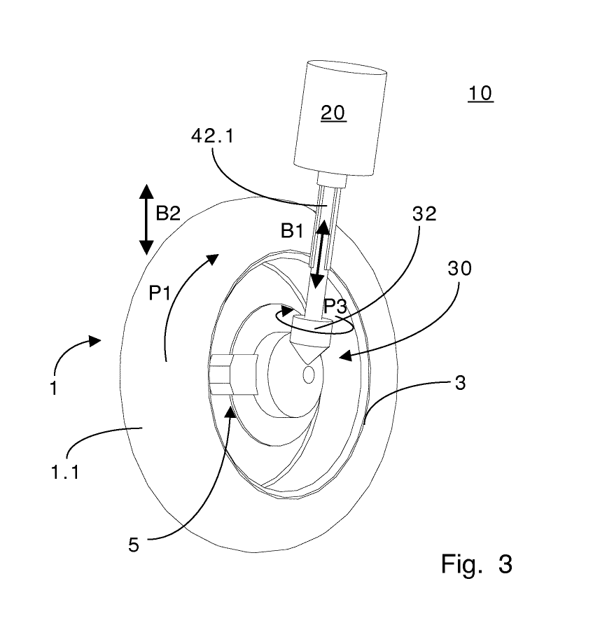

A further embodiment of the invention is shown in FIG. 3. The individual elements of this embodiment may correspond to those of FIG. 2A or 2A′. One of the cited coupling shafts 42.1 is also used here. However, it may be seen in FIG. 3 that the bevel gear pair 30 is preferably housed in a housing 32, in order to protect the bevel gear pair 30 from contamination. In addition, the housing 32 comprises bearings for the pinion 30.1 and for the crown wheel 30.2. The precise installation position of the pinion 30.1 and the crown wheel 30.2 is predetermined by the use of a housing 32 having bearings. Even during an up-and-down movement B2 of the wheel 1, the installation position of pinion 30.1 and crown wheel 30.2 is maintained. Only the cited coupling shaft 42.1 executes corresponding compensation movements B1.

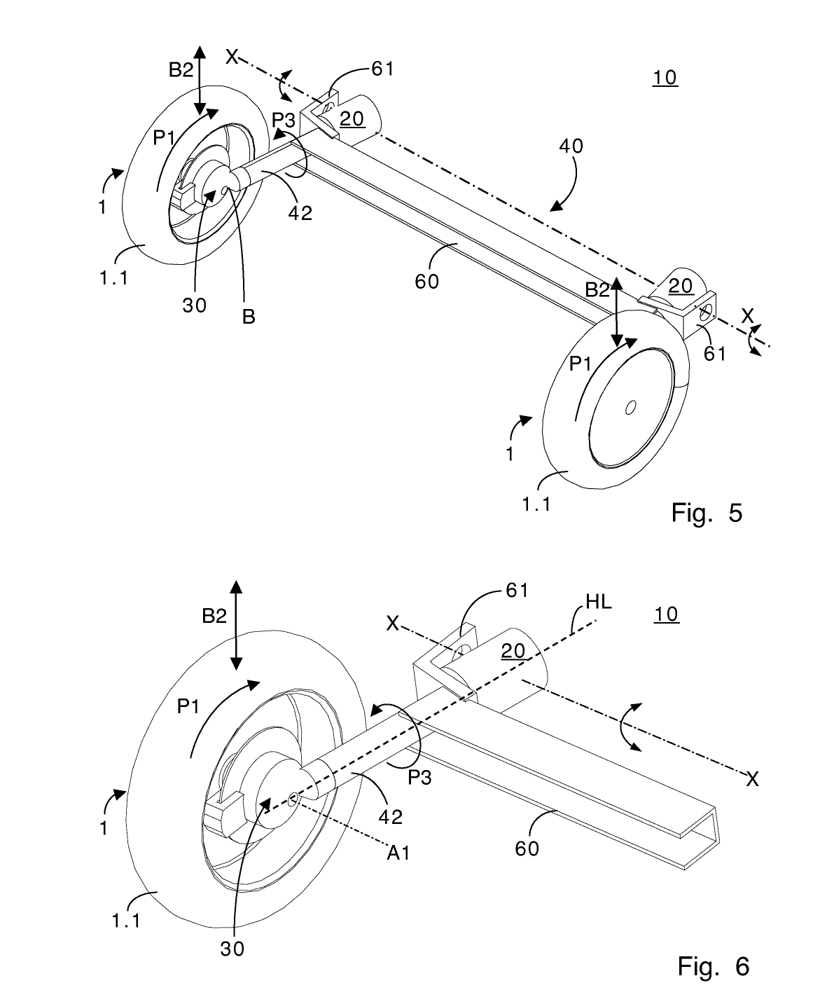

Such a housing 32 can also be used in all other embodiments. In addition, the shaft 42 or the coupling shaft 42.1 can be seated in the various embodiments in a housing, as may be seen in FIG. 5, for example. A protective sleeve is preferably used as a housing for the coupling shaft 42.1. A folded bellows coupling 42.1 according to FIG. 2C does not require such a protective sleeve as a housing.

A further embodiment of the invention is shown in FIG. 4. This embodiment is particularly preferred and is particularly suitable for use on a front wheel of a vehicle. The individual elements of this embodiment may correspond to those of FIG. 3. A coupling shaft 42.1 is also used here. However, it may be seen in FIG. 4 that the coupling shaft 42.1 is seated in the interior of a spring 44. The electric motor 20 is located at the upper end of the spring 44 and is connected to the vehicle. The spring 44 is a part of the wheel suspension 40.

An embodiment is shown in FIG. 4′ which corresponds to the embodiment of FIG. 4. The essential difference is that a significantly larger and higher-torque electric motor 20 is used. Such larger electric motors are used, for example, if the vehicle is to be equipped with better driving performance. It can be seen directly on the basis of FIG. 4′ that such an electric motor 20 could not be housed in the interior of the rim 3 of the wheel 1. However, one has sufficient degrees of freedom to also use significantly larger motors 20 through the wheel-adjacent configuration.

The embodiment of FIGS. 4 and 4′ may be ideally integrated in a MacPherson spring strut axle. MacPherson spring strut axles are particularly cost-effective and space-saving and are used in most mass-produced vehicles.

The electric motor 20 is also not part of the unsprung mass, but rather the sprung mass of the vehicle in this embodiment.

A further embodiment of the invention is shown in FIG. 5. This embodiment is particularly preferred and is particularly suitable for use on the rear wheels of a vehicle. The individual elements of this embodiment may correspond to those of the other embodiments. A part of the wheel suspension 40 is shown in this figure. A crossbeam 60 is used, which is connected to the vehicle body of the vehicle at two points using angles 61. These vehicle-side points of the wheel suspension 40 also define a neutral line X-X again here, as in FIG. 1A and FIG. 1A′. In the embodiment shown, an electric motor 20 is associated with each of the wheels 1. The electric motors 20 are again preferably seated precisely on the line X-X in order to ensure that the spacing between the electric motors 20 and the wheel hubs, or the axle A1, does not change. However, it is not absolutely necessary for the electric motors 20 to be seated precisely on this line X-X. They may also be situated somewhat adjacent to this line.

FIG. 6 shows details of the embodiment according to FIG. 5. The connection line HL between the electric motor 20 and the wheel hub, or the axle A1, is shown in FIG. 6 as a dashed line. This connection line HL is coincident with the longitudinal axis of the shaft 42. The shaft 42 rotates around this longitudinal axis, as indicated by the double arrow P3.

If the electric motor 20 is not seated on the neutral line X-X in one of the embodiments, this results in small leverages, which may have a negative influence on the suspension behavior of the vehicle. The principle described here of the drive-technology connection of the electric motor 20 to the wheel 1 still functions, however.

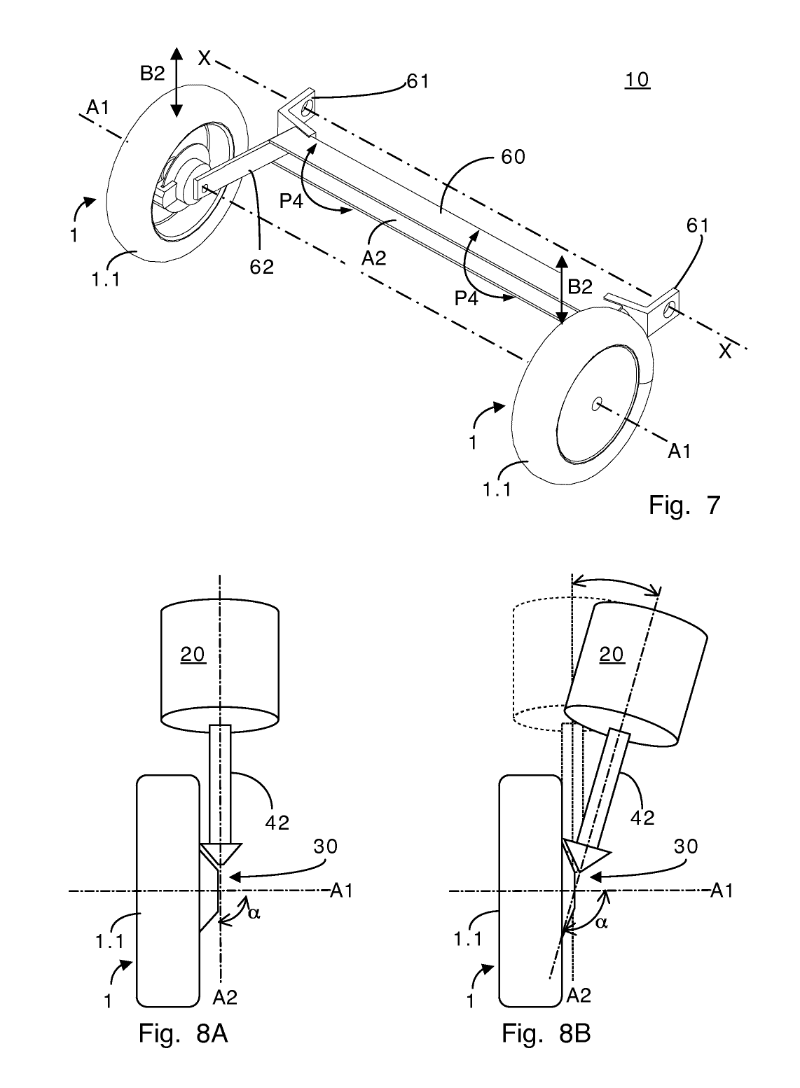

A different but similar rear wheel suspension 40 is shown in FIG. 7. It may be seen in FIG. 7 that the crossbeam 60 can be connected using legs 62 to the housing 32 of the bevel gear pair 30. The shaft 42 (not shown in FIG. 7) can (but does not have to) run parallel to these legs 62 (also referred to as guiding trailing arms). The crossbeam 60 and the wheels 1 fastened thereon can make a pivot movement around the line X-X, as indicated by the double arrows P4. This pivot movement occurs if the wheels move upward or downward, as shown by the double arrow B2. The crossbeam 60 is also used here as a torsion element, which can twist into itself in order to decouple the movements of the two rear wheels from one another.

Spring struts and/or shock absorbers and/or torsion elements (e.g., torsion bar springs) may be used as part of the wheel suspension 40 in FIGS. 5, 6, and 7, in order to damp the movements B2. These springs or torsion elements are not shown in the figures.

Such a primary rear axle suspension, as shown in FIGS. 5, 6, and 7, was primarily used up to this point for non-driven rear wheels, because this type of wheel suspension is particularly simple, space-saving, and cost-effective. The crossbeam 60 used as the connection profile makes a complex mount on the vehicle floor superfluous and can partially replace the stabilizer. According to the invention, such a simple rear axle configuration can be readily equipped with two electric drives, without having to perform large structural changes.

The embodiment according to FIG. 5, FIG. 6, and FIG. 7 may be ideally integrated in known trailing arm axles and twist-beam axles. Twist-beam axles are particularly cost-effective and space-saving and are used in many mass-produced vehicles. Such a twist-beam axle is known, for example, from DE 196 42 995 C1.

The invention may also be used similarly in individually suspended rear wheels, however.

Details of electric motors 20 which are particularly suitable for use in connection with the invention are disclosed hereafter.

The highest power density (ratio of power to overall size and weight) is achieved using permanently-excited synchronous motors 20. For this purpose, a three-phase current which can be regulated in frequency, voltage, and current is generated with the aid of a frequency converter, the three-phase current generating an electromagnetic rotary field in the stator of the electric motor 20. The rotor carries permanent magnets as the field-producing components, above all rare earth materials such as neodymium-iron-boron (in English neodymium-ferrite-boron or NeFeB in short) or samarium-cobalt (SmCo in short) are outstandingly suitable, because of high remanence and coercive field strength values, for a compact rotor of a permanently-excited synchronous electric motor 20.

The stator of the electric motor 20 is typically externally located and is connected to the housing, the rotor is internally located and is directly connected to the shaft. The shaft of the electric motor 20 is again connected without a gear to the shaft 42 or to the ball spline shaft 42.1.

Synchronous motors may additionally be advantageously used as generators, in order to convert the kinetic energy upon braking back into electrical energy in the vehicle.

Synchronous motors which are designed for low speeds require a high number of poles and thus a large number of costly magnets. The required diameter of the rotor in order to attach the magnets also rises with the number of poles. The costs and the weight for the high number of magnets and windings as well as the large diameter speaks against the use of such multipole electric motors.

Electric motors 20 having rated speeds of 4000-6000 rpm require a significantly lower number of poles, and may therefore be produced as very compact, light, and cost-effective. This type of electric motor 20 is therefore preferred in connection with the invention.

The following electric motor 20 is particularly suitable in connection with the invention.

Permanently-excited high-performance synchronous motor having the following characteristics:
nominal power approximately 20 KW,
nominal speed 6000 rpm,
nominal torque 40 Nm,
overall size approximately 200 mm length, approximately 200 mm diameter
weight approximately 20 to 30 kg per electric motor 20.

A vehicle equipped with such electric motors 20 on each wheel reaches a total power of approximately 80 kW (approximately 109 hp). This installation size may be housed readily as a wheel-adjacent motor according to the invention.

With an electric motor attached directly on the wheel, the weight of 20 to 30 kg would cause significant disadvantages in the driving behavior.

In a midrange vehicle, at a highest velocity of 180 kph, a speed of 1500 rpm is required on the wheel 1 (the wheel circumference for the widespread tire size 205/55-16 is approximately 2 m). Reductions of 1:3 to 1:4 may be implemented particularly advantageously using a bevel gear pair 30. An efficiency of 98.5% including the bearings is typical using modern bevel gear pairs 30 and is thus at a comparable level as spur gear pairs. In combination with the electric motor 20 cited in the example and a bevel gear pair 30 having the reduction 1:4, the maximum wheel speed specified above and a torque of 160 Nm per wheel are achieved (minus the efficiency loss of 1.5%).

A bevel gear pair 30, which is designed optimally for this exemplary embodiment, has a size at the crown wheel 42.2 of approximately 120 mm diameter. The total weight with housing 32 and bearings is approximately 4 kg.

A bevel gear pair 30 according to the invention comprises, as described, a bevel gear pinion 30.1 and a corresponding bevel gear crown wheel 30.2. Pinion 30.1 and crown wheel 30.2 together form a bevel gear pair. Greatly varying bevel gears, including hypoid bevel gears, may be used.

Further electric motors which may be used in connection with the invention are listed hereafter. In externally-excited synchronous motors, permanent magnets are not used, but rather the magnetic field of the rotor is electrically generated. Slip rings and corresponding maintenance are required for this purpose. These electric motors are to be found more in higher power ranges, but may also be used here under certain circumstances.

In asynchronous motors, the magnetic field of the rotor is induced by the rotary field of the stator winding in the rotor. The rotor has a slip relative to the electrical rotary field. However, the rotor does not carry magnets, but rather typically comprises iron packets (squirrel-cage rotors). Asynchronous motors are particularly cost-effective and low-maintenance due to this simple construction, also without slip rings.

In most cases, these asynchronous motors are operated directly on the AC mains, so that the speed is proportional to the mains frequency. These asynchronous motors are the typical work machines in manifold applications up into the highest power stages. Regulated applications may also be implemented in connection with frequency converters. However, complex regulating procedures, as are required in machine tools, are not typical due to the fundamental slip. These asynchronous motors may also be here used under certain circumstances.

DC motors require a collector and thus need maintenance. The power density is less than in synchronous motors. The significance of DC motors has dropped significantly due to the currently available high-performance frequency converters, which are required for the regulated operation of synchronous and asynchronous motors. DC motors may also be used under certain circumstances here.

A further advantage of the invention is schematically indicated in FIGS. 8A and 8B. An electric motor 20 can be situated in relation to the wheel 1 so that its axis A2 is perpendicular to the wheel axis A1. This situation is shown in FIG. 8A. Because the electric motor 20 may possibly come into contact with the tire 1.1 of the wheel 1 here, a constellation is selected in which the electric motor 20 is seated outside the circumference laterally adjacent to or above the wheel 1. The length L of the shaft 42 is preferably greater than the radius R of the wheel 1 here.

FIG. 8B shows that the bevel gear pair 30 can be designed so that the shaft 42 tapers at an inclined angle α toward the axle A1. This angle α is greater than 90° here. According to FIG. 8B, the electric motor 20 can be seated laterally directly adjacent to the tire 1.1 or laterally adjacent to or above the wheel 1.

The angle α is preferably between 85° and 120°.

1. Vehicle, comprising
a wheel suspension,
a wheel to be driven, which is connected to the vehicle using the wheel suspension;
an electric motor,
and wherein the vehicle also comprises:
a bevel gear pair, which is directly connected to the wheel and has a fixed gear reduction;
a shaft, which is situated between the electric motor and the bevel gear pair so that the electric motor is connected by means of drive technology to the wheel using the shaft and the bevel gear pair,
the fastening of the electric motor to the vehicle being designed so that the electric motor is essentially decoupled from wheel movements of the wheel as far as relative movements are concerned, and wherein the shaft, which drivingly connects the electric motor with the wheel, extends from a neutral pivotal point at the vehicle end of the wheel suspension to a pivotal point of the wheel end of the wheel suspension.

2. Vehicle according to claim 1, wherein the electric motor is part of the sprung mass of the vehicle due to the fastening of the electric motor.

3. Vehicle according to claim 1, wherein
the electric motor is either situated completely outside the circumference of the wheel, or
the electric motor is situated laterally adjacent to a tire of the wheel,
the electric motor being situated outside a rim of the wheel in both cases.

4. Vehicle according to claim 2, wherein the electric motor is situated outside the circumference of the wheel and the shaft has a shaft length which approximately corresponds to the radius of the wheel.

5. Vehicle according to claim 2, wherein the electric motor is situated outside the wheel center, laterally adjacent to a tire of the wheel, and the shaft has a shaft length which is shorter than the radius of the wheel.

6. Vehicle according to claim 1, wherein the connection of the electric motor is designed so that it is capable of executing an angular movement in relation to the wheel.

7. Device for use in a vehicle, which has a wheel to be driven, which is connected to the vehicle using a wheel suspension, wherein the device comprises:
an electric motor for mounting on the vehicle which is essentially decoupled as far as relative movements are concerned;
a bevel gear pair, having a fixed gear reduction, which is directly connected to the wheel;
a shaft for a drive connection of the electric motor to the bevel gear pair,
the components of the device being designed so that in the installed state
the electric motor is part of the sprung mass of the vehicle,
the electric motor is connected using the shaft to the bevel gear pair so that the electric motor is either off-center outside the circumference of the wheel or laterally adjacent to a tire of the wheel, and
wherein the shaft, which provides the drive connection of said electric motor with said bevel gear pair, extends from a neutral pivotal point at the vehicle end of the wheel suspension to a pivotal point at the wheel end of the wheel suspension.

8. Device according to claim 7, wherein the electric motor can be mechanically fastened in the area of the vehicle-side end of a wheel suspension, which is directly connected to the vehicle.

9. Device according to claim 8, wherein the shaft
is a ball spline shaft having variable shaft length, or
is a folded bellows connection having variable shaft length, or
is a drive kinematic unit having variable shaft length, or
is a coupling shaft having variable shaft length,
in order to be able to maintain a drive connection between the bevel gear pair and the electric motor in spite of longitudinal movement in relation to the wheel, this longitudinal movement preferably being a movement which is oriented vertically or slightly inclined to a road covering.

10. Device according to claim 7, wherein the electric motor is designed so that it is capable of executing an angular movement in relation to the wheel through the connection to the vehicle-side end of the wheel suspension.

11. Device according to claim 7, said the device being designed so that the connection between the bevel gear pair and the electric motor is maintained in spite of the angular movements, the shaft, which connects the electric motor to the wheel, can be situated in the same neutral plane as said neutral pivotal point of said vehicle end of the wheel suspension and an axle of said wheel end of the wheel suspension.

12. Device according to claim 7, wherein the bevel gear pair is enclosed and/or mounted in a drive housing.

13. Vehicle according to claim 1, wherein
the electric motor is either situated completely outside the circumference of the wheel, or
the electric motor is situated laterally adjacent to a tire of the wheel,
the electric motor being situated outside a rim of the wheel in both cases.

14. Device according to claim 8, wherein the electric motor is designed so that it is capable of executing an angular movement in relation to the wheel through the connection to the vehicle-side end of the wheel suspension.

15. Device according to claim 8, said the device being designed so that the connection between the bevel gear pair and the electric motor is maintained in spite of the angular movements, the shaft, which connects the electric motor to the wheel, can be situated in the same neutral plane as said neutral pivotal point of said vehicle end of the wheel suspension and an axle of said wheel end of the wheel suspension.

16. Device according to claim 8, wherein the bevel gear pair is enclosed and/or mounted in a drive housing.
